(19) United States
(12) Patent Application Publication
(10) Pub. No.: US 2002/0184770 A1
(43) Pub. Date: Dec. 12, 2002

(54) Razor cartridge loading system

(76) Inventor: Mark S. Peyser, Easton, CT (US)

Correspondence Address: Gregg C. Benson, Pfizer Inc., Patent Department, MS 4159, Eastern Point Road, Groton, CT, 06340, US

(21) Appl. No.: 10/132,808

(22) Filed: Apr. 24, 2002

Related U.S. Application Data
(60) Provisional application No. 60/287,098, filed on Apr. 27, 2001.

(51) Int. Cl. B26B 21/16; B26B 21/52; B26B 21/24

(52) U.S. Cl. 30/50; 30/40.2; 30/526

(57) ABSTRACT

A system for loading a razor cartridge onto a securing element, such as a razor handle, includes a razor cartridge having a leading edge, a trailing edge, and side walls extending between the leading and trailing edges, each side wall having a projection extending outwardly therefrom, and a cartridge dispenser for releasably securing one or more of the razor cartridges. The cartridge dispenser includes a first end and a second end, sides extending between the first and second ends, and a cartridge holding area for releasably securing one or more of the razor cartridges to the dispenser. The cartridge holding area includes a pair of guide rails extending between the first and second ends of the dispenser, the guide rails extending away from one another. Each guide rail has a notch formed therein that is adapted to receive one of the projections of the razor cartridge when the razor cartridge is secured in the cartridge receiving area. The system also includes a securing element including a pair of flexible arms having a bearing with a slot adapted to receive one of the razor cartridge projections.

### CROSS-REFERENCE TO RELATED APPLICATIONS

The present application is a U.S. non-provisional application. This application claims the benefit of U.S. No. 60/287,098 filed on Apr. 27, 2001, under 35 USC 119(e).

### BACKGROUND OF THE INVENTION

The present invention relates to razors for shaving and is particularly directed to automatically loading a razor blade cartridge onto an end of a razor.

Razor cartridges are generally sold in razor cartridge dispensers designed to hold two, three or more razor cartridges. The razor cartridges are typically removed from the cartridge dispenser by securing a razor handle to one of the razor cartridges while the cartridge is retained within the dispenser. The razor handle may then be moved relative to the dispenser, such as by using the leverage of the handle against a friction or interference fit with the cartridge body, so as to secure the handle to the cartridge and free the cartridge from the dispenser. In embodiments where the razor cartridge is pivotable, the handle may be pivoted beyond the range of motion allowed by the pivotal connection before leverage is applied to the friction or interference fit.

Automatic cartridge loading systems are used to safely load razor cartridges onto the ends of razor handles. These systems generally comprise a razor handle that may be releasably secured to a cartridge to enable replacement of the razor cartridge when its blades become dull. A supply of replacement razor cartridges is typically carried in a cartridge dispenser. The cartridge dispenser allows a user to replace a razor cartridge without having to physically touch the worn cartridge or the replacement cartridge, thereby enhancing safety.

U.S. Pat. No. 5,946,805 to Oldroyd discloses a shaving system including a razor handle that may be detachably mounted to a razor blade unit and a dispenser that holds a plurality of blade units that are aligned in a row between entry and exit ends of the dispenser. Each razor blade unit has a guide for guiding the razor handle along the dispenser. During cartridge replacement, the handle is guided along the dispenser for disengaging the razor handle from a dull blade unit at the exit end of the row, and for engaging the razor handle to a replacement blade unit at the entry end of the dispenser.

U.S. Pat. No. 6,085,426 to Metcalf et al. discloses a cartridge dispenser for razor blade cartridges including latches that retain cartridges in predetermined positions, thereby permitting connection to a razor handle connecting structure of the handle as the handle is moved toward the cartridge. Each latch has a camming structure that is shaped and positioned to interact with a corresponding handle camming structure so as to cause the latch to be deflected and to unlatch a cartridge as the handle is connected to the cartridge connecting structure of a cartridge. The dispenser also has blade unit dividers that define blade unit regions in which the blade units are received.

U.S. Pat. No. 4,428,116 to Chen et al. discloses a shaving instrument, including an elongated support terminating in a yoke. The elongated support includes a slide element that is movable relative to the support from a first position in which the yoke is closed to a second position in which the yoke is flexed outwardly for receiving a blade cartridge. A spring biases the slide element toward the first position for retaining the cartridge in the yoke.

U.S. Pat. No. 4,403,414 to Kiraly et al. discloses a socket device used for pivotally connecting a cartridge and a support. The connection between the socket and the support is accomplished by interlocking arcuate flanges, the connection between the socket and cartridge being formed by cooperation between a channel and a track.

In spite of the above-mentioned advances, there remains a need for improved automatic cartridge loading systems.

### SUMMARY OF THE INVENTION

In accordance with certain preferred embodiments of the present invention, a razor assembly includes a razor cartridge having a leading edge, a trailing edge and sidewalls extending between the leading and trailing edges, each sidewall having an arcuate-shaped projection extending therefrom. The assembly also preferably includes a securing element including a pair of flexible arms, each flexible arm having a bearing with an arcuate-shaped slot adapted to receive one of the arcuate-shaped projections of the razor cartridge for releasably attaching the securing element to the razor cartridge. The arcuate-shaped slots and the arcuate-shaped projections desirably have curvatures that mirror or are substantially similar to one another.

Each of the flexible arms preferably has a lower end including one of the bearings, whereby the arcuate-shaped slots of the bearings have openings that oppose one another. The flexible arms are adapted to flex away from one another so that the arms may pass over the end walls of the razor cartridge for being attached to the projections of the razor cartridge. The sidewalls of the cartridge preferably define a first distance that is greater than the second distance between the openings of the arcuate-shaped slots of the bearings. The arcuate-shaped projections of the cartridge are preferably slidable within the arcuate-shaped slots of the bearings so that the razor cartridge may pivot relative to the securing element after the razor cartridge has been attached thereto.

In certain embodiments, the securing element comprises plastic. The flexible arms desirably have upper ends that may be connected to a common element such as a tie-bar. The flexible arms and the tie-bar may be integrally connected together. A biasing element may be connected and extend between the flexible arms for biasing the flexible arms toward one another. As such, the flexible arms are preferably normally biased toward one another.

In certain preferred embodiments, each flexible arm has an upper end, a guide flange between the bearing and the upper end, and a clearance gap extending between the bearing and the guide flange. The guide flange and the bearing slot of each flexible arm desirable extends in directions substantially parallel to one another.

In other preferred embodiments of the present invention, a razor cartridge loading system includes a razor cartridge having a leading edge, a trailing edge, and sidewalls extending between the leading and trailing edges, each of the sidewalls having a projection extending outwardly therefrom. The system also desirably includes a cartridge dispenser including first and second ends, sidewalls extending between the first and second ends, and a cartridge holding area for releasably securing the razor cartridge to the dispenser. The cartridge holding area includes a pair of guide rails extending between the first and second ends of the dispenser, the guide rails extending away from one another. Each of the guide rails desirably has a notch formed therein that is adapted to receive one of the projections of the razor cartridge. The system also desirably includes a securing element including a pair of flexible arms, each of the flexible arms having a lower end including a bearing with a slot adapted to receive one of the projections of the razor cartridge. The cartridge projections and the bearing slots preferably have arcuate shapes that are substantially mirror images of one another so that the cartridge projections may slide within the arcuate-shaped slots of the bearings.

The flexible arms of the securing element are desirably engagable with the guide rails of the dispenser. The guide rails extend away from one another to such an extent that the distance between the bearings becomes greater than the distance between the sidewalls of the razor cartridge. During a cartridge loading operation, the bearings of the securing element are abutted against the guide rails. As the securing element is moved toward the second end of the dispenser, the outwardly extending guide rails force the flexible arms away from one another. Thus, the guide rails serve to expand the distance between the bearings at the lower ends of the flexible arms. As the securing element is moved toward the second end of the dispenser, the bearings of the securing element ultimately are in substantial alignment with the notches formed in the guide rails. At this point, the arcuate-shaped slots of the bearings slide over the arcuate-shaped projections of the razor cartridge. As mentioned above, the arcuate-shaped projections of the razor cartridge project through the notches of the guide rails so that the slots of the bearings may slide over the projections. After the arcuate-shaped projections are secured within the arcuate-shaped slots of the securing element, the razor cartridge is able to pivot freely relative to the bearings of the securing element. Such pivoting is desirable for providing a smooth and comfortable shaving performance. In certain preferred embodiments, the flexible arms are movable between a first undeflected orientation before the securing element engages the guide rails and a second deflected orientation when the securing element is moved toward the second end of the dispenser and the bearings are adjacent the notches in the guide rails.

In certain embodiments, a biasing element may be connected between the flexible arms of the securing element for biasing the flexible arms toward one another. In some of these embodiments, the upper ends of the flexible arms may be pivotally secured to a tie-bar. In other embodiments, the flexible arms of the securing element may be secured to an upper end of a razor handle. The securing element may be a stand-alone razor handle or may include structure for being attached to a razor handle.

In certain preferred embodiments, the guide rails of the dispenser include vertical retention flanges adjacent the notches formed in the guide rails. In these embodiments, the flexible arms include upper ends, a guide flange between the bearing and the upper end, and a clearance gap between the bearing and the guide flange. As the securing element moves toward the second end of the dispenser, the vertical retention flanges maintain the vertical orientation of the bearings relative to the projections of the razor cartridge. As a result, the vertical retention flanges are adapted to pass through the clearance gap of each of the flexible arms. As the vertical retention flanges pass through the clearance gaps, the vertical retention flanges pass between the guide flange of each flexible arm and the bearing of such flexible arm at the lower end thereof.

These and other preferred embodiments of the present invention will be described in more detail below.

### BRIEF DESCRIPTION OF THE DRAWINGS

FIG. 1 shows a perspective view of a cartridge dispenser for a razor cartridge loading system, in accordance with certain preferred embodiments of the present invention.

FIG. 2 shows a perspective view of a razor cartridge, in accordance with certain preferred embodiments of the present invention.

FIG. 3 shows an expanded, fragmentary view of the razor cartridge shown in FIG. 2.

FIG. 4 shows a perspective view of a flexible securing element for securing the razor cartridge shown in FIG. 2, in accordance with certain preferred embodiments of the present invention.

FIG. 5 shows an expanded, fragmentary view of a portion of the flexible securing element shown in FIG. 4.

FIGS. 6A through 6E-1 show a method for loading the razor cartridge of FIG. 2 to the securing element of FIG. 4, in accordance with certain preferred embodiments of the present invention.

FIG. 7 shows an elevational view of the razor cartridge loading system shown of FIG. 6E taken along the line VII-VII of FIG. 6E.

FIG. 8 shows a perspective view of the razor cartridge loading system shown in FIG. 7.

FIG. 9 shows a top plan view of a razor cartridge loading system including a razor handle in accordance with other preferred embodiments of the present invention.

FIG. 10 shows a perspective view of the razor cartridge loading system of FIG. 9.

### DETAILED DESCRIPTION OF PREFERRED EMBODIMENTS

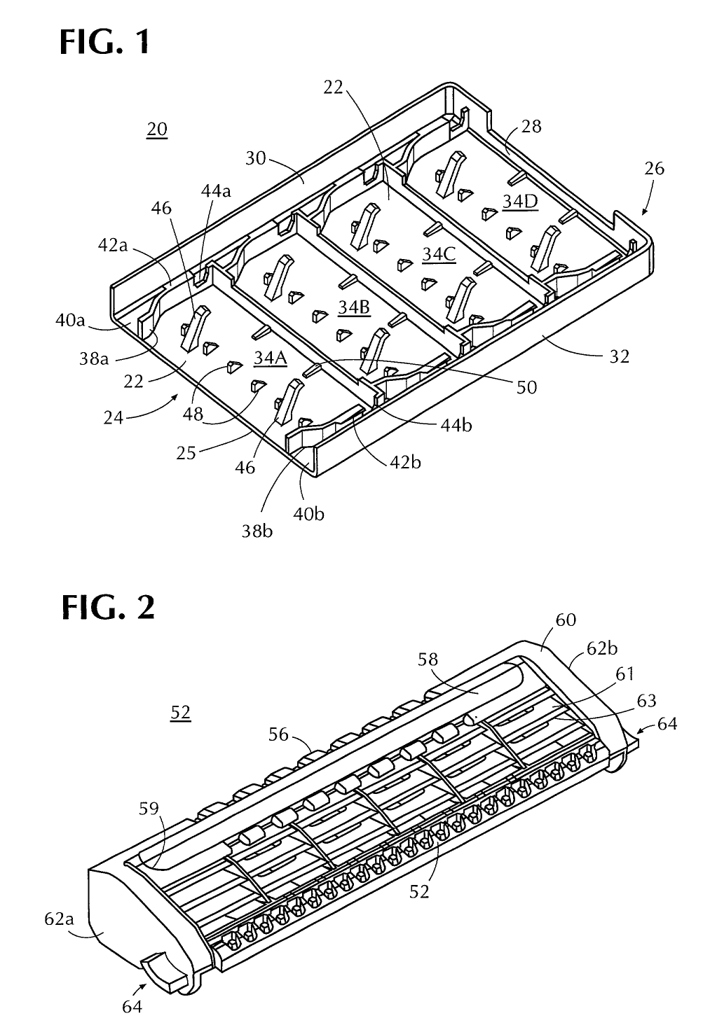

Referring to FIG. 1, in accordance with certain preferred embodiments of the present invention, a razor cartridge loading system includes a dispenser 20 having a bottom 22 extending between a first end 24 and a second end 26 remote therefrom. The dispenser 20 includes an end wall 28 at second end 26 and first and second sidewalls 30, 32 extending between end wall 28 and the first end 24 of the dispenser. The bottom 22 terminates at an edge 25 at the first end 24 of dispenser 20. Dispenser 20 also includes one or more cartridge holding areas. The dispenser 20 shown in FIG. 1 includes four cartridge holding areas designated 34A-34D that are substantially similar to one another in size, shape and dimension. The cartridge holding area 34A has a rear wall 36 and two guide rails 38A, 38B extending from edge 25 to rear wall 36. The guide rails 38A, 38B, include cammed surfaces that extend outwardly toward the respective sidewalls 30, 32 of the dispenser 20. The guide rails 38A, 38B and sidewalls 30, 32 define respective guide channels 40A, 40B therebetween. The guide rails 38A, 38B have vertical retention flanges 42A, 42B, respectively, that extend to respective notches 44A, 44B. In certain embodiments, the notches 44A, 44B preferably have a substantially U-shaped cross-section.

Dispenser 20 also desirably includes retention fingers 46 projecting upwardly from bottom 22. The retention fingers 46 are preferably integrally connected to bottom 22. In certain preferred embodiments, retention fingers 46 are resilient and may be made of a polymer material. Cartridge holding area 34A also preferably includes a row of forward cartridge standoffs 48, the row extending in a direction substantially parallel to edge 25 at the first end 24 of dispenser 20. Cartridge holding area 34A also preferably includes one or more rear cartridge standoffs 50. The forward and rear cartridge standoffs 48, 50 are adapted to prevent a top side of a razor cartridge from engaging bottom 22, which may result in one or more cutting blades of the razor blade cartridge being dulled. The rear cartridge standoffs 50 are integrally connected to bottom 22 and rear wall 36 of cartridge holding area 34A.

In other preferred embodiments, the first end 24 of dispenser 20 may be closed by a front end wall (not shown) substantially similar to the rear end wall 28 at the closed end 26 of the dispenser.

FIG. 2 shows a razor blade cartridge 52 that may be releasably secured within one of the cartridge holding areas 34A-34D shown in FIG. 1. The razor blade cartridge 52 includes many of the features disclosed in commonly assigned U.S. Pat. No. 4,443,939, the disclosure of which is hereby incorporated by reference herein. Razor blade cartridge 52 preferably includes a guard bar 54 secured along a leading edge of the cartridge, a trailing edge 56 and a lubricating strip 58 secured within an elongated channel 59 molded along a top side 60 of cartridge 52. Razor blade cartridge 52 is designed to hold one or more cutting blades 61 having cutting edges 63. Razor blade cartridge 52 also includes sidewalls 62A, 62B extending between the edge 54 and trailing edge 56. Each sidewall preferably includes a projection 64 integrally molded with the respective sidewalls 62A, 62B and projecting outwardly therefrom.

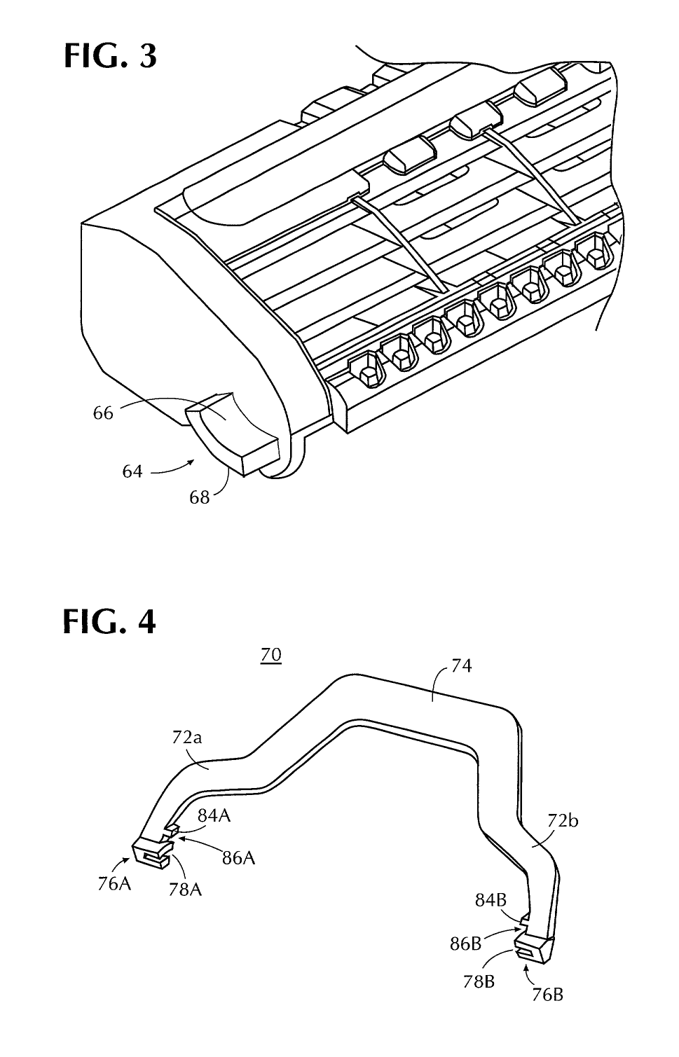

Referring to FIG. 3, each cartridge projection 64 preferably includes a first arcuate surface 66 at a top side thereof and a second arcuate surface 68 at an underside thereof. In certain preferred embodiments, the curvature of the first arcuate surface 66 is substantially similar to the curvature of the second arcuate surface 68.

FIG. 4 shows a flexible securing element 70 adapted to be selectively attached to the razor cartridge shown in FIG. 2. Flexible securing element 70 may have a yoke-like shape and may have opposing flexible arms 72A, 72B connected to one another through tie-bar 74. The lower ends of the flexible arms preferably include respective yoke bearings 76A, 76B having substantially arcuate-shaped slots 78A, 78B that oppose one another. Each flexible arm 72 also preferably includes a guide flange 84A, 84B integrally formed therewith and disposed between bearing 76 and tie-bar 74. Each flexible arm also has a guide channel 86A, 86B extending between the respective guide flanges 84 and bearings 76 of the flexible arms.

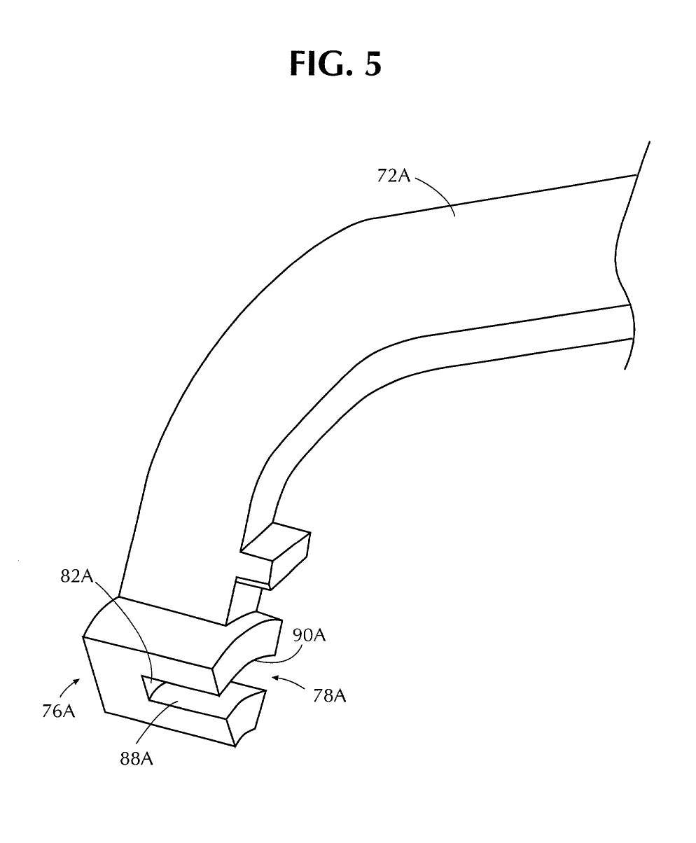

FIG. 5 shows an expanded view of a portion of flexible arm 72A including bearing 76A having an arcuate-shaped slot 78A extending between a lower arcuate surface 88A and an upper arcuate surface 90A. Arcuate shaped slot 78A has an open end facing toward an opposing flexible arm (not shown) and a closed end 82A. Flexible arm 72 also preferably includes guide flange 84 and guide channel 86 extending between bearing 76 and guide flange 84.

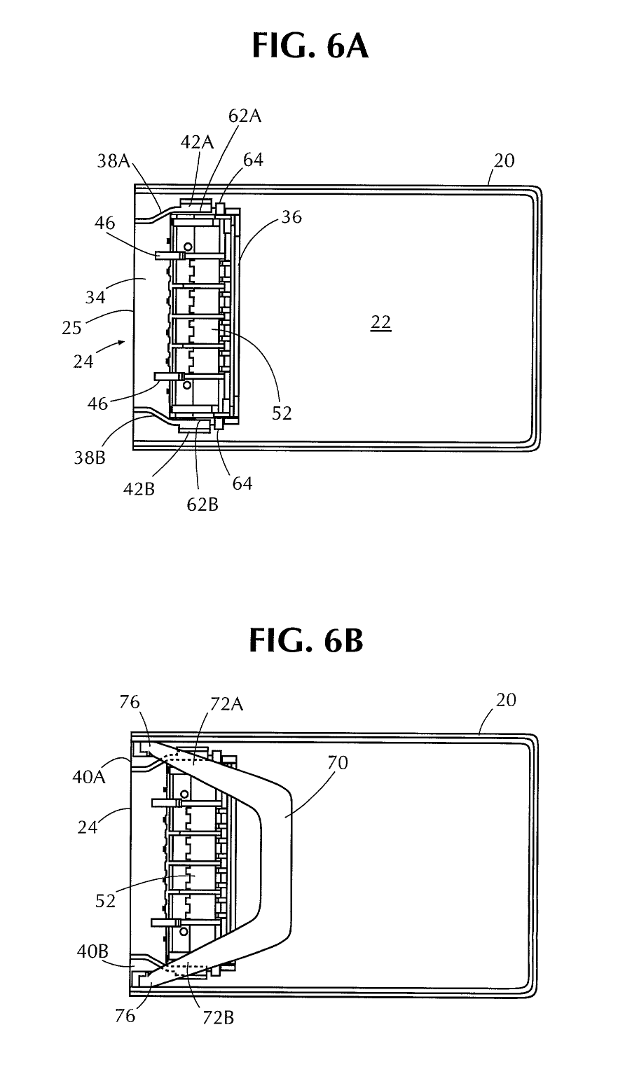

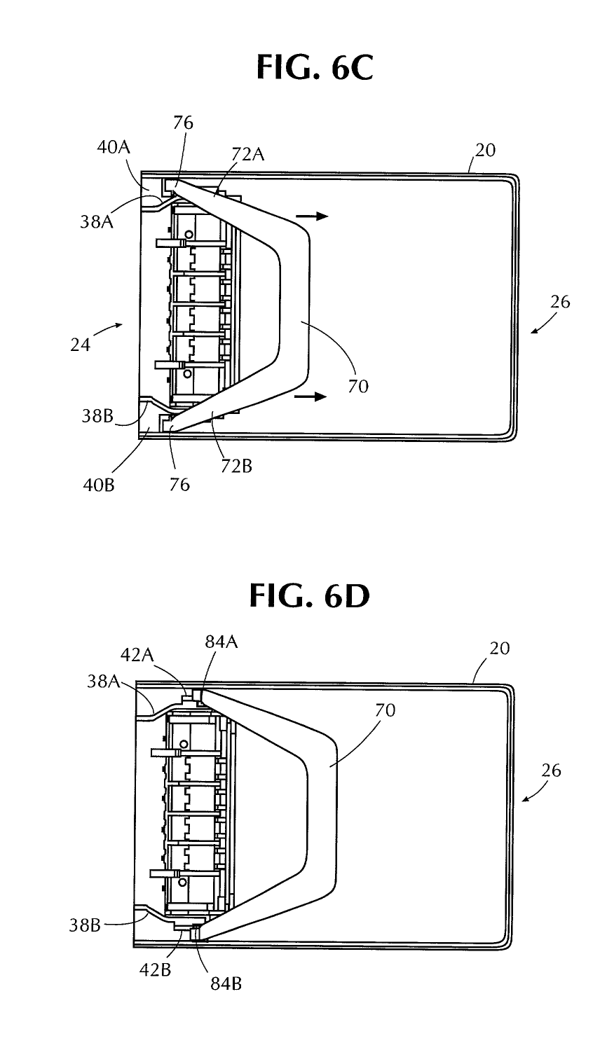

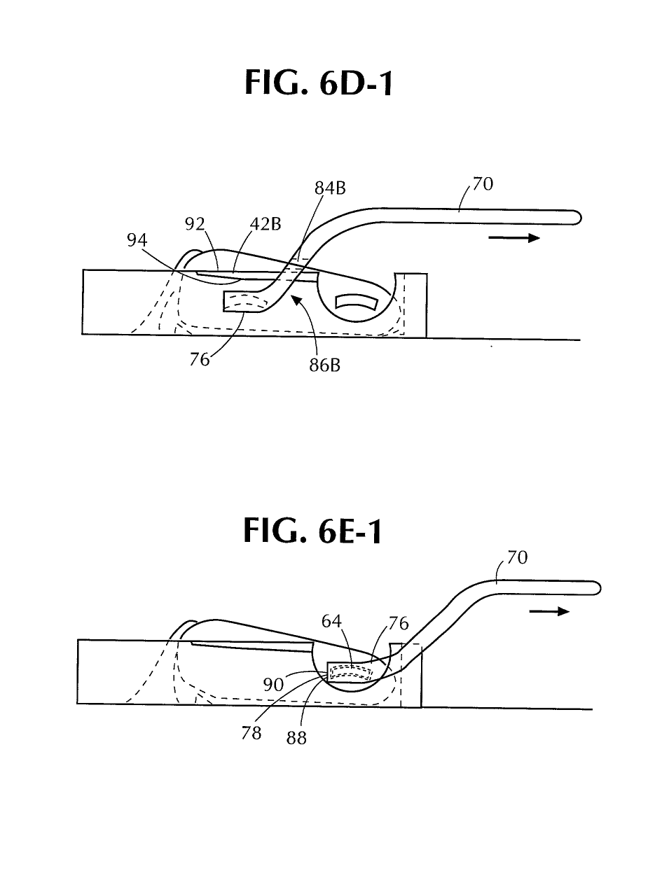

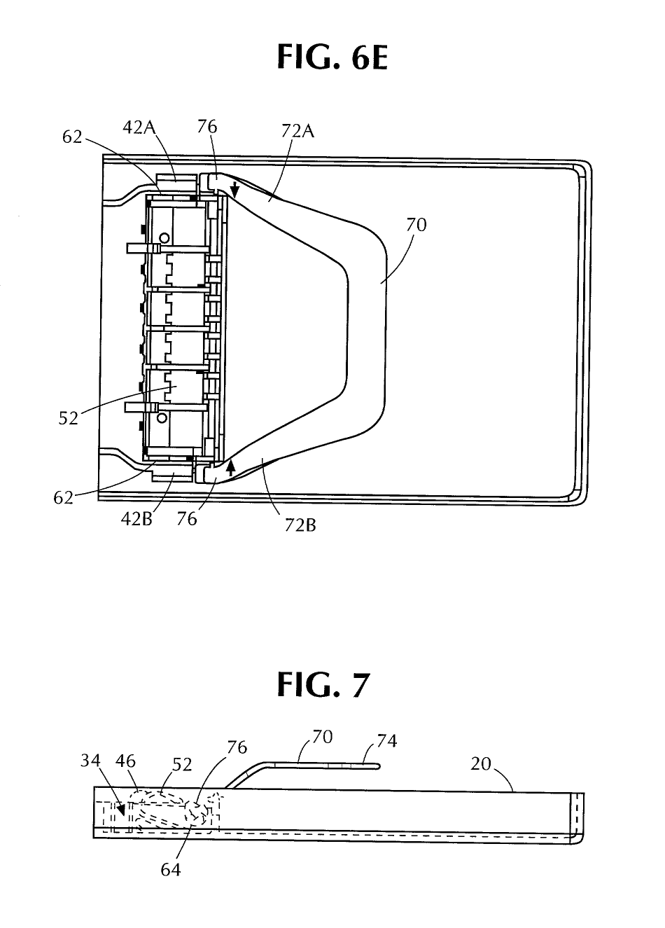

For purposes of clarity, FIGS. 6A-8 have been modified to show dispenser 20 having only one cartridge holding area 34. Referring to FIG. 6A, cartridge holding area 34 includes lateral guide rails 38A, 38B. Each guide rail extends from edge 25 at the open end 24 of dispenser 20 toward the second end 26 of the dispenser. The guide rails 38A, 38B preferably extend away from one another as one moves along the guide rails toward the closed end 26 of the dispenser. Each guide rail also preferably includes a vertical retention flange 42A, 42B. Cartridge holding area 34 preferably has a rear wall 36 extending between guide rails 38A, 38B. A cartridge 52 having substantially arcuate-shaped projections 64 projecting outwardly from sidewalls 62A, 62B thereof is secured in cartridge holding area 34. The cutting blades (not shown) of razor cartridge 52 face toward the bottom 22 of dispenser. Retention fingers 46 engage a portion of the razor cartridge body for securing the razor cartridge within the cartridge holing area 34. In order to secure the cartridge 52 to a flexible securing element 70, the respective bearings 76 of the flexible arms 72A, 72B are aligned with the guide channels 40A, 40B at the open end 24 of dispenser 20. The flexible securing element 70 is preferably made of a resilient or flexible material, such as plastic, so that the two arms 72A, 72B may flex outwardly and away from one another. The securing element 70 is preferably resilient so that the arms will bias back toward one another once any outwardly-directed forces on the flexible arms are removed.

Referring to FIG. 6C, as securing element 70 is slid in the guide channels 40A, 40B, toward the closed end 26 of dispenser 20, the outwardly extending guide rails 38A, 38B engage the bearings and force the flexible arms 72A, 72B away from one another.

In FIG. 6D, the flexible securing element 70 continues to move toward the closed end 26 of dispenser 20. The guide flanges 84A, 84B of securing element 70 are guided over vertical retention flanges 42A, 42B of guide rails 38A, 38B, while the bearings 76 pass below the vertical retention flanges 42A, 42B. At the same time, vertical retention flanges 42A, 42B pass through the clearance gap 86A, 86B (FIG. 4) between bearings 76 and guide flanges 84A, 84B.

FIG. 6D-1 shows a fragmentary view of securing element 70 passing by vertical retention flange 42B, with guide flange 84B passing over a top surface 92 of vertical retention flange 42B and bearings 76 of securing element 70 passing below a bottom surface 94 of vertical retention flange 42B. As a result, the outer edge of vertical retention flange passes through the clearance gap 86B between guide flange 84B and bearing 76.

FIGS. 6E and 6E-1 show the securing element 70 having bearings 76 secured over the projections (not shown) of cartridge 52. After the yoke bearings 76 pass by vertical retention flanges 42A, 42B, flexible arms 72A, 72B are free to return to their original unbiased configuration wherein the bearings 76 exert compressing forces on the respective end walls 62 of razor cartridge 52.

FIG. 6E-1 shows the cartridge projection 64 secured within the lower arcuate surface 88 and upper arcuate 90 of bearing slot 78. In certain preferred embodiments, the curvature of the cartridge bearing 64 substantially matches the curvature of the lower and upper arcuate surfaces 88, 90 of slot 78 of bearing 76.

FIG. 7 shows a side elevational view of FIG. 6E-1. When securing element 70 is initially attached to cartridge 52 in dispenser 20, the tie-bar 74 of securing element 70 extends over dispenser 20. The dispenser 20 includes the at least one cartridge 52 secured in cartridge holding area 34. Cartridge 52 is held in place by one or more retention fingers 46 abutting against cartridge 52. Securing element 70 is attached to cartridge bearings 64 on opposite ends of cartridge 52 by bearing 76.

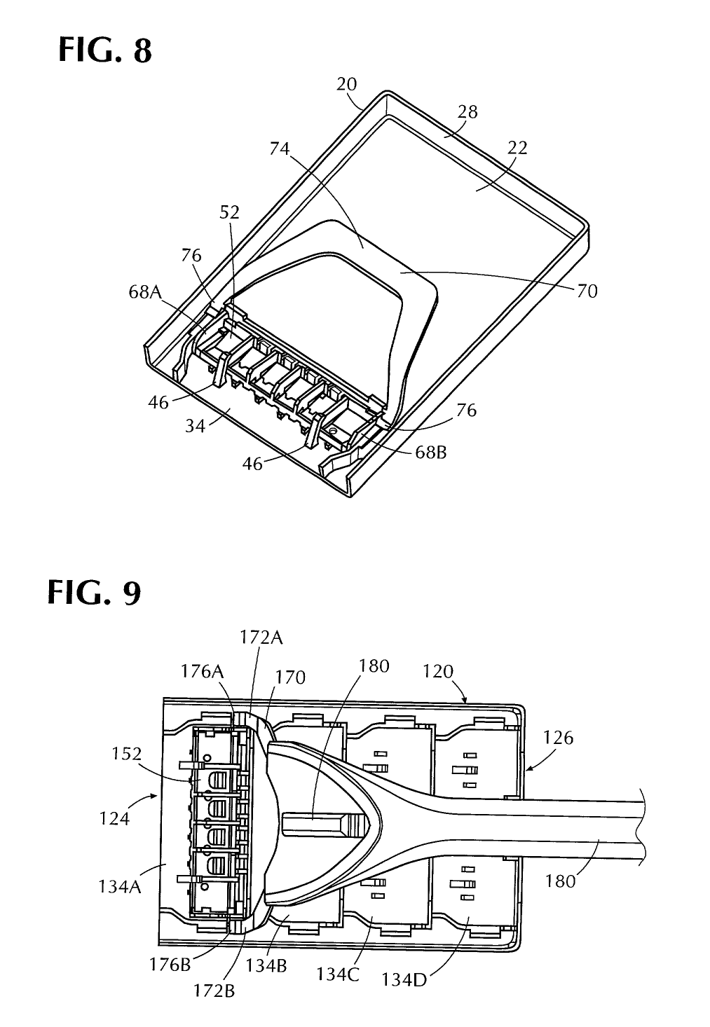

FIG. 8 shows a perspective view of securing element 70 attached to the cartridge projections (not shown) extending from opposing sidewalls 68A, 68B of cartridge 52. The cartridge 52 may be removed from the cartridge holding area 34 of dispenser 20 by rotating the tie-bar portion 74 of securing element 70 away from the bottom 22 of dispenser 20. In other words, the tie-bar 74 is moved away from bottom 22 and away from the end wall 28 of dispenser 20. As the securing element 70 is rotated, the razor cartridge 52 is slightly rotated up and away from the bottom 22, whereby the razor cartridge is released by retention fingers 46. At this point, the cartridge projections (not shown) extending from the sidewalls 68A, 68B of razor cartridge 52 are secured within the slots of respective bearings 76 of securing element 70. The secured attachment of razor cartridge 52 to securing elements 70 will allow an individual to utilize the razor cartridge 52 during a shaving operation.

FIG. 9 shows a razor loading cartridge system in accordance with other preferred embodiments of the present invention including dispenser 120 having a series of cartridge receiving areas 134A-134D extending between a first end 124 and a second end 126 dispenser 120. A razor handle 180 is secured to a tie-bar (now shown) of securing element 170. The bearings 176A, 176B are secured over cartridge projections (not shown) of razor blade cartridge 152. Razor handle 180 includes a moveable or depressible button 182 that may be actuated for detaching razor handle 180 from the securing element and/or flexing the flexible arms 172A, 172B outwardly from one another.

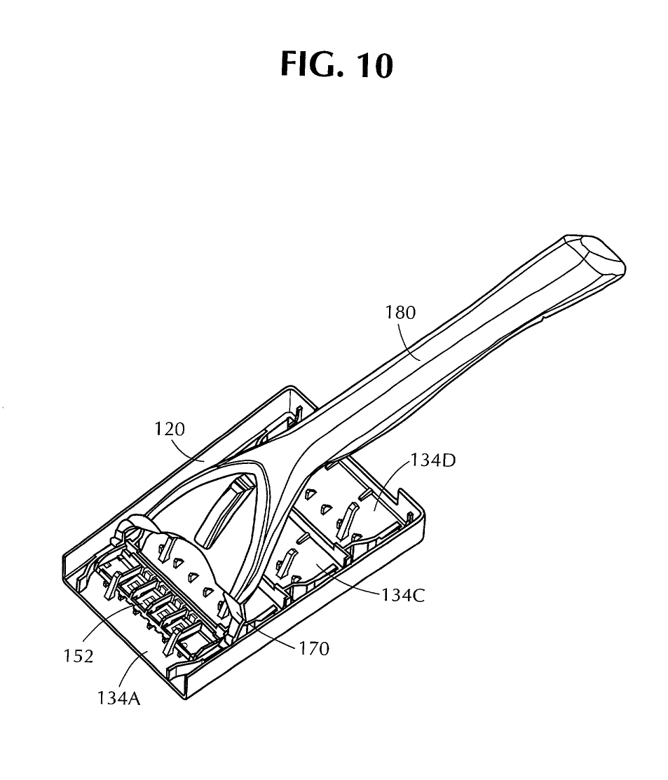

FIG. 10 shows a perspective view of the cartridge loading system of FIG. 9 including razor handle 180 and securing element 170 attached to a razor cartridge 152 provided in a cartridge receiving area 134A of cartridge dispenser 120. Although the cartridge dispenser 120 shown in FIG. 10 includes four cartridge receiving areas designated 134A-134D, other preferred embodiments of the invention may include cartridge dispensers having 1, 2, 3, or any number of cartridge receiving areas contemplated by one skilled in the art.

Although the present invention has been described with reference to particular embodiments, it is to be understood that the disclosed embodiments are merely illustrative of the principles and applications of the present invention. Thus, numerous modifications may be made to the disclosed embodiments without departing from the spirit and scope of the present invention as defined by the appended claims.

1. A razor assembly comprising:
a razor cartridge including a leading edge, a trailing edge, and side walls extending between the leading and trailing edges, each said side wall having an arcuate-shaped projection extending therefrom; and
a securing element including a pair of flexible arms, wherein each said flexible arm includes a bearing having an arcuate-shaped slot adapted to receive one of the arcuate-shaped projections of said razor cartridge for releasably attaching said securing element to said razor cartridge.

2. The razor assembly as claimed in claim 1, wherein said arcuate-shaped slots and said arcuate-shaped projections have curvatures that are substantially similar to one another.

3. The razor assembly as claimed in claim 2, wherein each said flexible arm has a lower end including one of the bearings, wherein the arcuate-shaped slots of the bearings have openings that oppose one another.

4. The razor assembly as claimed in claim 3, wherein said flexible arms are adapted to flex away from one another for passing over the end walls of said razor cartridge.

5. The razor assembly as claimed in claim 4, wherein the sidewalls of said cartridge define a first distance that is greater than a second distance between the openings of said arcuate-shaped slots.

6. The razor assembly as claimed in claim 1, wherein the arcuate-shaped projections of said cartridge are slidable within the arcuate-shaped slots of said securing element so that said razor cartridge is pivotable relative to said securing element.

7. The razor assembly as claimed in claim 1, wherein said flexible arms are normally biased toward one another.

8. The razor assembly as claimed in claim 1, wherein said securing element comprises plastic.

9. The razor assembly as claimed in claim 1, wherein said flexible arms have upper ends connected to a tie bar.

10. The razor assembly as claimed in claim 1, further comprising a biasing element connected to said flexible arms for biasing said flexible arms toward one another.

11. The razor assembly as claimed in claim 1, wherein each said flexible arm has an upper end, a guide flange between the bearing and the upper end, and a clearance gap between said bearing and said guide flange.

12. The razor assembly as claimed in claim 11, wherein said guide flange and said bearing slot of each said flexible arm extend in directions substantially parallel to one another.

13. The razor assembly as claimed in claim 1, wherein said flexible arms are integrally connected to a tie bar extending therebetween.

14. The razor assembly as claimed in claim 13, wherein said flexible arms and said tie bar are integrally connected.

15. The razor assembly as claimed in claim 1, wherein said razor cartridge is adapted to have one or more cutting blades secured therein, a guard bar secured to the leading edge of said cartridge and a lubricating strip secured to the trailing edge of said cartridge.

16. A razor cartridge loading system comprising:
a razor cartridge having a leading edge, a trailing edge, and side walls extending between the leading and trailing edges, each said side wall having a projection extending outwardly therefrom;
a cartridge dispenser including first and second ends, sidewalls extending between the first and second ends, and a cartridge holding area for releasably securing said razor cartridge to said dispenser, said cartridge holding area including a pair of guide rails extending between the first and second ends of said dispenser, said guide rails extending away from one another, wherein each said guide rail has a notch formed therein adapted to receive one of the projections of said razor cartridge.

17. The system as claimed in claim 16, further comprising a securing element including a pair of flexible arms, wherein each said flexible arm has a lower end including a bearing with a slot adapted to receive one of the projections of said razor cartridge.

18. The system as claimed in claim 17, wherein the flexible arms of said securing element are engagable with the guide rails of said dispenser, and wherein the guide rails force the flexible arms away from one another as said securing element is moved toward the second end of said dispenser.

19. The system as claimed in claim 16, wherein said cartridge projections and said bearing slots have arcuate shapes that are substantially mirror images of one another.

20. The system as claimed in claim 19, wherein the arcuate-shaped slots at the lower ends of said flexible arms have openings that oppose one another.

21. The system as claimed in claim 20, wherein said flexible arms are movable between a first undeflected orientation and a second deflected orientation, and wherein said flexible arms are adapted for passing over the side walls of said razor cartridge when in the second deflected orientation.

22. The system as claimed in claim 21, wherein the side walls of said cartridge define a first distance that is greater than a second distance between the openings of said arcuate-shaped slots.

23. The system as claimed in claim 19, wherein said arcuate-shaped projections are slidable within said arcuate-shaped slots of said securing element so that said razor cartridge is pivotable relative to said securing element.

24. The system as claimed in claim 17, wherein said flexible arms are normally biased toward one another.

25. The system as claimed in claim 24, further comprising a biasing element connected to said flexible arms for biasing said flexible arms toward one another.

26. The system as claimed in claim 17, wherein each said flexible arm has an upper end, a guide flange between the bearing and the upper end, and a clearance gap between said bearing and said guide flange.

27. The system as claimed in claim 26, wherein the guide rails of said dispenser include a vertical retention flange for controlling the vertical orientation of said bearing slots relative to said cartridge projections.

28. The system as claimed in claim 27, wherein the vertical retention flanges are adapted to pass through the clearance gap of each said flexible arm, between the guide flange and the bearing of each said flexible arm.
